(19) United States
(12) Patent Application Publication
(10) Pub. No.: US 2026/0226585 A1
(43) Pub. Date: Aug. 6, 2026

(54) SELECTIVE SEPARATION OF METALS FROM MINERAL-RICH CONCENTRATES

(71) Applicant: US Metals Refining Group, Inc., Centennial, CO (US)

(72) Inventor: Henry W. KASAINI, Centennial, CO (US)

(21) Appl. No.: 19/153,277

(22) PCT Filed: Feb. 1, 2024
(86) PCT No.: PCT/US2024/014105

§ 371 Date: Aug. 1, 2025

Related U.S. Application Data
(60) Provisional application No. 63/442,518, filed on Feb. 1, 2023.

(51) Int. Cl. C22B 60/02; C22B 3/12; C22B 3/22; C22B 3/38; C22B 3/44; C22B 26/20; C22B 59/00

(52) U.S. Cl. CPC C22B 60/0291; C22B 3/12; C22B 3/22; C22B 3/3842; C22B 3/44; C22B 26/20; C22B 59/00

(57) ABSTRACT

Methods for the processing of mineral-rich ore concentrates for the selective recovery of rare earth metals from the concentrates. Methods may include digestion of the mineral-rich ore concentrates in caustic sodium hydroxide and the subsequent separation of non rare earth elements to form a high purity rare earth product. The methods may provide a shortened path from the mineral-rich ore concentrate to high purity rare earth metals, reduced reagent costs, reduced energy consumption, little or no effluent and the formation of valuable by-products to reduce the overall operating cost of the method.

### FIELD

This disclosure relates to the separation and recovery of high purity rare earth metals from a mineral-rich concentrate including base metals.

### BACKGROUND

Methods are known for the separation of valuable rare earth elements from mineral ore concentrates containing minerals such as bastnasite and monazite. However, the selective extraction of the rare earth elements can be difficult due to the presence of other metals or compounds that are often found with these minerals. For example, the extraction of rare earth elements from bastnasite-rich ores may be complicated by the presence of calcium, iron, aluminum, manganese and thorium in these ores. The extraction of rare earth elements from monazite-rich ores may be complicated by the presence of aluminum, phosphates, calcium, iron, titanium, thorium and manganese.

### SUMMARY

The present disclosure is directed to methods for the selective extraction of rare earth elements from mineral ore concentrates. The methods are particularly applicable to the extraction of rare earth elements from mineral ore concentrates that include bastnasite and/or monazite with appreciable quantities of one or more of aluminum, phosphates, calcium, iron, titanium, thorium, manganese and barium.

In one embodiment, a method is disclosed for the selective extraction of metals from a mineral-rich concentrate comprising compounds of rare earth metals, aluminum, phosphorous, thorium, barium and base metals comprising at least iron and manganese.

The method includes the steps of: (i) contacting the mineral-rich concentrate with a caustic sodium hydroxide solution at a temperature of at least about 130° C. and at a weight ratio of sodium hydroxide to mineral-rich concentrate of at least about 1:1 to form metal hydroxide compounds comprising at least rare earth metal hydroxides, thorium hydroxide and barium hydroxide, and a rare earth metal depleted sodium hydroxide solution comprising a solubilized Na—Al—P complex; (ii) filtering off the metal hydroxide compounds from the rare earth metal depleted sodium hydroxide solution; and (iii) recovering Na—Al—P complex crystals from the rare earth metal depleted sodium hydroxide solution.

In another embodiment, a method is disclosed for the separation of metal hydroxide compounds of rare earth metals, thorium and barium, from a mixture of those metal hydroxide compounds with base metal hydroxide compounds comprising iron hydroxide and manganese hydroxide. The method includes the steps of: (i) contacting the mixture of metal hydroxide compounds with sulfuric acid and oxalic acid to form insoluble oxalate/double sulfate precipitates comprising rare earth metal oxalates, rare earth metal double sulfates, thorium oxalate, barium sulfate and an acidic liquid comprising solubilized base metals; and (ii) filtering off the oxalate/double sulfate precipitates from the acidic liquid.

In another embodiment, a method is disclosed for the conversion of a mixture of metal oxalate compounds and metal double sulfate compounds to metal hydroxide compounds. The method includes the steps of: (i) contacting the mixture of metal oxalate compounds and metal double sulfate compounds with a caustic sodium hydroxide solution to metathesize the metal double sulfate compounds and the metal oxalate compounds to insoluble metal hydroxide compounds and form (a) metal hydroxide compounds comprising rare earth metal hydroxides, thorium hydroxide, cerium hydroxide and barium hydroxide, and that is substantially free of sulfate and oxalate compounds, and (b) a bulk solution comprising sodium oxalate; (ii) filtering off the metal hydroxide compounds from the bulk solution; and (iii) calcining the metal hydroxide compounds at a temperature of at least about 670° C. in an oxidizing atmosphere to form calcined metal oxide compounds comprising rare earth metal oxides, barium oxide, silicate compounds, cerium oxide having cerium in a +4 valence state and thorium oxide having thorium in a +4 valence state.

In another embodiment, a method is disclosed for the recovery of barium from metal oxide compounds comprising rare earth metal oxides, barium oxide, calcium oxide, silicate compounds, cerium oxide and thorium oxide. The method includes the steps of: (i) contacting the metal oxide compounds with nitric acid to form a bulk nitrate solution comprising solubilized rare earth metal nitrates, barium nitrate, calcium nitrate, cerium nitrate and thorium nitrate, and a gangue phase comprising silicate compounds; (ii) filtering off the bulk nitrate solution from the gangue phase; (iii) contacting the bulk nitrate solution with a substantially stoichiometric amount of sulfuric acid to precipitate barium sulfate from the bulk nitrate solution and form a barium-depleted nitrate solution; and (iv) filtering off the barium sulfate from the barium-depleted nitrate solution.

In another embodiment, a method is disclosed for the recovery of thorium and cerium from a bulk nitrate solution comprising thorium and rare earth metals including cerium. The method includes the steps of: (i) contacting the bulk nitrate solution with a an extractant mixture comprising at least about 20 wt. % dialkyl phosphinic acid extractant in a diluent at an oxygen-reduction potential (ORP) of at least about 1000 mV and not greater than about 1500 mV and a pH of about pH 1 or less; (ii) wherein at least about 99.9% of the thorium and at least about 75% of the cerium from the bulk nitrate solution are extracted in a single extraction step, and (iii) wherein the thorium and the cerium in the bulk nitrate solution are in the +4 oxidation state.

The foregoing methods may be implemented alone or in any combination. In one embodiment, the foregoing methods are combined to provide a method for the extraction and recovery of high purity rare earth metals from a mineral-rich concentrate.

### DESCRIPTION OF THE DRAWINGS

The figures attached hereto are illustrative of several embodiments of the present disclosure, but are not to be construed as limiting the embodiments disclosed herein.

FIG. 1 illustrates a method for the selective extraction of metals from a mineral-rich concentrate according to an embodiment.

FIG. 2 illustrates a method for the separation of base metal compounds from hydroxide compounds according to an embodiment.

FIG. 3 illustrates a method for the conversion of a mixture of metal oxalate compound particulates and metal double sulfate compound particulates to metal hydroxide compound particulates according to an embodiment.

FIG. 4 illustrates a method for the recovery of barium and calcium from an oxide particulate phase according to an embodiment.

FIG. 5 illustrates a method for the recovery of thorium and cerium from a bulk nitrate solution comprising rare earth metals according to an embodiment.

FIG. 6 illustrates a method for the extraction of rare earth metals as rare earth metal oxides from a mineral-rich concentrate according to an embodiment.

FIG. 7 illustrates a method for the extraction of high purity rare earth metal from rare earth metal oxides according to an embodiment.

### DESCRIPTION

In one embodiment, a method for the separation and recovery of rare earth metals from a mineral-rich ore concentrate, e.g., a mineral feedstock, is disclosed. Rare earth metals, i.e., rare earth elements, refer to the metals lanthanum, cerium, praseodymium, neodymium, promethium, samarium, europium, gadolinium, terbium, dysprosium, holmium, erbium, thulium, ytterbium, lutetium, scandium and yttrium. Rare earth elements may be referred to in this disclosure and in the drawings as Re. Although the present disclosure is not limited to mineral-rich concentrates containing a specific concentration of rare earth metals, the mineral-rich concentrate may include at least about 2 wt. % total rare earth metals on an elemental metals basis (e.g., as a weight percentage of all metals contained in the mineral-rich concentrate), such as at least about 4 wt. % rare earth metals, or even at least about 6 wt. % rare earth metals. Typically, the mineral-rich concentrate will include not greater than about 25 wt. % rare earth metals, such as not greater than about 20 wt. % rare earth metals, such as not greater than about 15 wt. % rare earth metals. As used herein, all references to weight percentage or mass percentage of a metal refers to an elemental metals basis, e.g., as a weight percentage of all metals contained in the mineral-rich concentrate, unless otherwise specified.

The mineral-rich concentrate may be a raw material that comprises at least one mineral selected from the group consisting of monazite and bastnaesite. Monazite is an example of a phosphate mineral that contains appreciable concentrations of rare earth metals, typically in the form of rare earth metal phosphates. The rare earth metals contained in a mineral-rich concentrate comprising monazite may particularly include, but are not limited to, cerium, lanthanum and neodymium. Bastnaesite is a carbonate-fluoride mineral that contains appreciable amounts of rare earth metals, particularly cerium and lanthanum. It will be appreciated that the mineral-rich concentrate that is processed according to the present disclosure may comprises mixtures of two or more minerals, e.g., a mixture of monazite and bastnaesite. Further, the methods disclosed herein may be applied to other similar feedstocks that include appreciable quantities of rare earth metals.

The mineral-rich concentrates may also include base metals, typically in the form of base metal oxides. As used herein, the term base metals refers to the following metals: copper, lead, nickel, zinc, iron, aluminum, tin, tungsten, molybdenum, tantalum, cobalt, bismuth, cadmium, titanium, zirconium, antimony, manganese, beryllium, chromium, germanium, vanadium, gallium, hafnium, indium, niobium, rhenium and thallium. In addition to rare earth metals and base metals, the mineral-rich concentrates may include thorium, e.g., in the form of thorium phosphate. The mineral-rich concentrate may also comprise uranium, which is often found associated with mineral deposits that include appreciable quantities of rare earth metals. Further, the mineral-rich concentrate may include appreciable concentrations of barium, e.g., in the form of barium oxide.

In one particular characterization, the mineral-rich concentrate comprises aluminum. As is discussed in more detail below, some of the methods disclosed herein are particularly useful for the treatment of mineral-rich concentrates comprising appreciable concentrations of rare earth metals and appreciable concentrations of aluminum. Although the present disclosure is not limited to any particular concentration of aluminum in the mineral-rich concentrate, in one characterization the mineral-rich concentrate comprises at least about 2 wt. % aluminum, such as at least about 4 wt. % aluminum, such as at least about 5 wt. % aluminum. Typically, the mineral-rich concentrate will comprise not greater than about 15 wt. % aluminum, such as not greater than about 10 wt. % aluminum, such as not greater than about 8 wt. % aluminum.

The mineral-rich concentrate may also comprise appreciable concentrations of phosphorus, such as at least about 5 wt. % phosphorus or higher. In one characterization, the phosphorus is present in a greater concentration than the aluminum, e.g., in a weight ratio of greater than about 1:1. In one characterization, the weight ratio of phosphorus to aluminum is at least about 1.1:1, such as at least about 1.2:1 or even at least about 1.3:1. If desired, the slurry mixture in the stirring reactor may be supplemented with additional phosphorus to increase the ratio to aluminum.

In another characterization, the mineral-rich concentrate comprises appreciable concentrations of barium. Although the present disclosure is not limited to any particular concentration of barium in the mineral-rich concentrate, and the mineral-rich concentrate may be substantially free of barium, in one characterization the mineral-rich concentrate includes at least about 5 wt. % barium, such as at least about 10 wt. % barium. Typically, the mineral-rich concentrate will comprise not greater than about 35 wt. % barium, such as not greater than about 30 wt. % barium, such as not greater than about 25 wt. % barium. As with aluminum, the methods disclosed herein may be particularly suitable for the treatment of mineral-rich concentrates containing such appreciable concentrations of barium.

In another characterization, the mineral-rich concentrate also includes appreciable concentrations of titanium.

The mineral-rich concentrate may be formed from a raw mineral ore, e.g., by beneficiation of the raw ore and the removal of gangue from the raw mineral ore.

The composition of an exemplary mineral-rich concentrate that may be treated according to the present disclosure is listed in Table I.

TABLE I

| Element | Range (wt. %) |
|---|---|
| P | 5%-12% |
| Ca | 3%-6% |
| A | 5%-8% |
| Ti | 1%-4% |
| Fe | 16%-45% |
| Mn | 2%-5% |
| Ba | 10%-25% |
| Rare Earth Metals | 4%-15% |
| Th | 0.02%-0.4% |
| U | 0.0001%-0.03% |

It may be desirable that the mineral-rich concentrate have a relatively fine particle size to facilitate processing of the mineral-rich concentrate. In one refinement, the mineral-rich concentrate may have an average particle size of not greater than about 50 μm, such as not greater than about 40 μm, such as not greater than about 30 μm, such as not greater than about 20 μm, or even not greater than about 10 μm. As used herein, the average particle size may be measured by a technique such as laser diffraction or dynamic light scattering. Although there is no particular minimum average particle size, as a practical matter the mineral-rich concentrate will have an average particle size of at least about 1 μm. If needed, methods for reducing the average particle size of raw materials such as mineral-rich concentrates are well known to those skilled in the art.

According to one embodiment of the present disclosure, a method for the selective extraction, e.g., separation, of metals from a mineral-rich concentrate comprising rare earth metals, aluminum, phosphorus, thorium, barium and other base metals is disclosed. The base metals may include iron and manganese. The foregoing method is subject to a number of characterizations and refinements according to the present disclosure. In one refinement, the mineral-rich concentrate comprises at least monazite, e.g., a monazite ore concentrate. In another refinement, the mineral-rich concentrate comprises at least carbonatite, e.g., a carbonatite ore concentrate. The mineral-rich concentrate may also be characterized as comprising iron as another base metal. In another characterization, the mineral-rich concentrate comprises calcium.

As noted above, the mineral-rich concentrate comprises appreciable (e.g., more than trace) quantities of rare earth metals. In one characterization, the mineral-rich concentrate comprises at least about 4 wt. % rare earth metals, such as at least about 6 wt. % rare earth metals, such as at least about 8 wt. % rare earth metals, at least about 10 wt. % rare earth metals, or even at least about 12 wt. % rare earth metals. Typically, the mineral-rich concentrate will include not greater than about 25 wt. % rare earth metals, such as not greater than about 20 wt. % rare earth metals. As is also noted above, the mineral-rich concentrate also includes aluminum. For example, the mineral-rich concentrate may be characterized as comprising at least about 2 wt. % aluminum, such as at least about 3 wt. % aluminum, such as at least about 4 wt. % aluminum, or even at least about 5 wt. % aluminum. In another characterization, the mineral-rich concentrate may include not greater than about 10 wt. % aluminum, such as not greater than about 8 wt. % aluminum. Further, the mineral-rich concentrate also includes barium. In one characterization, the mineral-rich concentrate includes at least about 2 wt. % barium, such as at least about 3 wt. % barium, such as at least about 4 wt. % alum barium, or even at least about 5 wt. % barium. As a practical matter, the mineral-rich concentrate will typically not include greater than about 25 wt. % barium, such as not greater than about 20 wt. % barium.

The method, referred to herein as an aluminum extraction method, includes the steps of contacting the mineral-rich concentrate with a caustic sodium hydroxide solution to form metal hydroxide compounds, e.g., to form metal hydroxide precipitates, that include rare earth metal hydroxides, thorium hydroxide and barium hydroxide. A caustic liquid filtrate is also formed that is rare earth metal depleted, e.g., contains little to no rare earth metals, and includes sodium hydroxide as well as aluminum and phosphorus, e.g., in the form of a solubilized Na—Al—P complex.

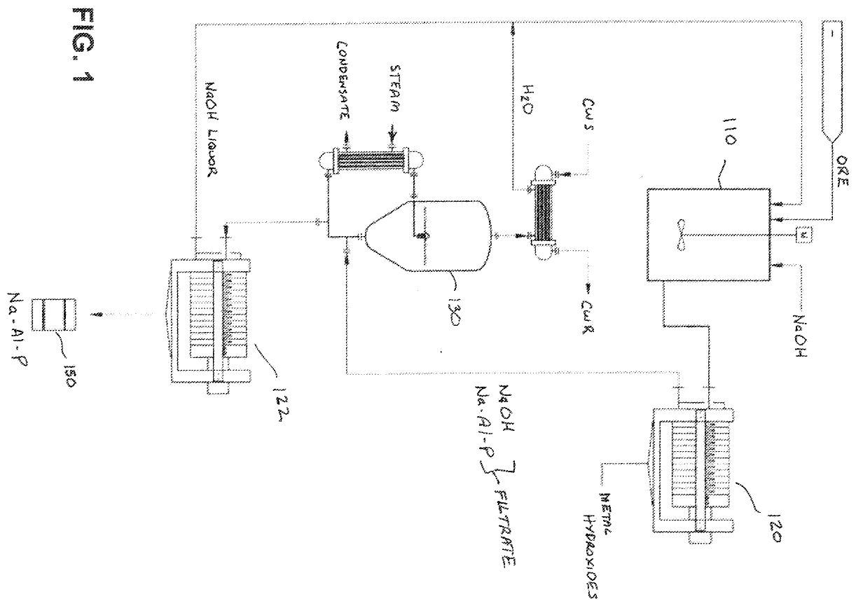

FIG. 1 schematically illustrates such a method. A mineral-rich concentrate (feed ore) is contacted with caustic sodium hydroxide (NaOH) in a mixer/reactor 110. In one characterization, the contacting step may be implemented at an elevated temperature such as at least about 120° C., at least about 125° C., at least about 130° or even at least about 135° C. As a practical matter, the contact temperature will be not greater than about 160° C., such as not greater than about 155° C. or not greater than about 150° C. A particularly preferred contact temperature may be at least about 130° C. and not greater than about 140° C. For example, the mixer/reactor 110 may include heating elements to elevate and control the contact temperature.

The step of contacting the mineral-rich concentrate with caustic sodium hydroxide may also be carried out using a particular ratio of sodium hydroxide to mineral-rich concentrate. In one characterization, the weight ratio, e.g., the mass ratio, of sodium hydroxide (NaOH) to mineral-rich concentrate in the reactor is at least about 0.9:1, such as at least about 1:1, such as at least about 1.2:1 or even at least about 1.5:1. In another characterization, the weight ratio of sodium hydroxide to mineral-rich concentrate is not greater than about 2.5:1, such as not greater than about 2.2:1. The caustic sodium hydroxide solution may have a concentration of at least about 40 wt. % NaOH, such as at least about 45 wt. % NaOH, and not greater than about 60 wt. % NaOH, such as not greater than about 55 wt. % NaOH. The caustic sodium hydroxide solution may also be characterized as having a pH of at least about pH 11, such as at least about pH 11.5, or even at least about pH 12.

In another characterization, the contacting step initially forms a slurry, e.g., a mixture of the solid mineral-rich concentrate particles in the caustic sodium hydroxide. In this regard, the initial concentration of sodium hydroxide solution to the mineral-rich concentrate in the mixer/reactor 110 may have a relatively low solids content. In one characterization, the slurry in the mixing reactor initially has a solids concentration of not greater than about 30 wt. %, such as not greater than about 25 wt. %, or even not greater than about 20 wt. %.

Contacting the mineral-rich concentrate with sodium hydroxide under the foregoing conditions will result in the selective precipitation of metal hydroxide compounds, e.g., the formation of metal hydroxide precipitates, in a sodium hydroxide solution. The metal hydroxide compounds will include rare earth metal hydroxides, and may also include thorium hydroxide, barium hydroxide and certain base metal hydroxides when those metals are present in the mineral-rich concentrate. Advantageously, most of the aluminum and phosphorous will be solubilized in the sodium hydroxide solution, which will include little to no rare earth metals, e.g., a rare earth metal depleted sodium hydroxide solution. The metal hydroxide compounds are then separated from the rare earth metal depleted sodium hydroxide solution, e.g., in a filter press 120. Na—Al—P complex crystals may be recovered from the rare earth metal depleted sodium hydroxide solution, such as by chilling the solution in a chiller 130 and then separating the Na—Al—P complex precipitates from the sodium hydroxide solution, e.g., in a filter press 122. The Na—Al—P complex precipitates are a valuable by-product for use as a fertilizer. The sodium hydroxide filtrate (NaOH liquor) may advantageously be recycled to the step of contacting the mineral-rich concentrate with caustic sodium hydroxide solution in the mixer 110.

Although not illustrated in FIG. 1, the metal hydroxide compounds separated from the rare earth metal depleted sodium hydroxide solution may be transferred back to the mixer/reactor 110 for a second contacting step, e.g., to further reduce the concentration of aluminum that may initially report to the metal hydroxides. In one characterization, at least about 98% of the aluminum in the mineral-rich concentrate ultimately reports to the sodium hydroxide filtrate, such as at least about 99% of the aluminum.

The mineral-rich concentrate is contacted, e.g., in a mixer reactor, with a caustic sodium hydroxide (NaOH) solution, e.g., a first caustic sodium hydroxide solution, to form a caustic slurry. The objective of this contacting step is to form a hydroxide precipitate phase (e.g., a first hydroxide precipitate phase) comprising rare earth metal hydroxides, thorium hydroxide and barium hydroxide, and to form a caustic liquid (e.g., the caustic liquid filtrate) comprising sodium hydroxide, aluminum and phosphorus, e.g., where at least a portion of the aluminum and phosphorus from the mineral-rich concentrate is digested by the caustic sodium hydroxide solution.

To facilitate the foregoing objectives, this contacting step may occur at an elevated temperature, e.g., a temperature that is above ambient temperature. For example, this contacting step may be carried out at a temperature of at least about 100° C., such as at least about 120° C., at least about 130° C. or even at least about 140° C. To further facilitate the foregoing objectives, the contacting step forms a slurry having a relatively low solids content, e.g., within a reaction vessel. For example, the slurry may have solids content of not greater than about 20 wt. %, such as not greater than about 15 wt. %, such as not greater than about 12 wt. %. In one particular refinement, the slurry has a solids content of about 10 wt. %. It is believed that forming a slurry having such a solids content will facilitate the removal of aluminum to the caustic liquid, e.g., to the filtrate. In another characterization, the weight ratio of the phosphates to the aluminum in the caustic slurry is at least about 1:1, such as at least about 1.1:1.

In another characterization, the caustic sodium hydroxide solution has a concentration of at least about 30% NaOH, such as at least about 35% NaOH, such as at least about 40% NaOH, or even at least about 45% NaOH. In one particular refinement, the caustic sodium hydroxide solution comprises about 50% NaOH. In another characterization, the caustic sodium hydroxide solution has a pH of at least about pH 11, such as at least about pH 12.

The foregoing step of contacting the mineral-rich concentrate with a caustic sodium hydroxide solution advantageously results in a large proportion of the aluminum reporting to the liquid phase while the rare earth elements report to the solid precipitate phase in the form of rare earth metal hydroxides. In one characterization, at least about 98% of the rare earth metals from the mineral-rich concentrate report to the hydroxide precipitate phase, such as at least about 99%, at least about 99.5% or even at least about 99.9%. In another characterization, at least about 60% of the aluminum reports to the caustic liquid phase, such as at least about 70% or even at least about 75%. Because this step is highly selective for the separation of aluminum from the rare earth metals, the contacting step may be repeated as necessary, e.g. by recycling the hydroxide precipitate phase back to a second contacting step, to further reduce the concentration of aluminum in the hydroxide precipitate phase to a desired level. In one refinement, one or more additional contacting steps are repeated in this manner until the concentration of aluminum in the hydroxide precipitate phase is not greater than about 0.5 wt. %, such as not greater than about 0.25 wt. %, such as not greater than about 0.1 wt. % or even not greater than about 0.05 wt. %.

After separation of the hydroxide precipitate phase from the caustic liquid solution, e.g., the caustic liquid filtrate, the caustic liquid filtrate will include sodium hydroxide with aluminum and phosphorus from the mineral-rich concentrate. In one refinement, sodium aluminum phosphate (Na—Al—P) is crystallized from the caustic liquid filtrate, e.g., by evaporative crystallization, and may be sold as a valuable by-product. The sodium hydroxide solution may then be recycled to the initial contacting step.

Thus, the aluminum extraction method described above and illustrated in FIG. 1 enables the selective removal of aluminum from a mineral-rich concentrate that also includes rare earth metals, thorium, barium and other base metals such as iron and manganese.

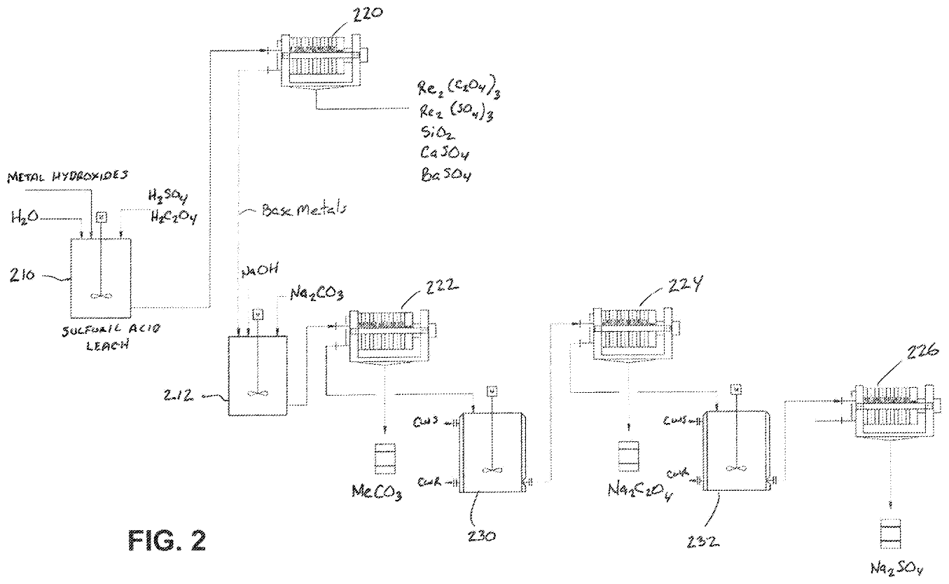

According to another embodiment, and as illustrated in FIG. 2, a method is also disclosed herein for the separation of metal hydroxide compounds of rare earth metals, thorium and barium from base metal hydroxide compounds, e.g., comprising at least iron hydroxide and manganese hydroxide. This method, referred to herein as a sulfuric acid leach, may be carried out independently, or the method may be integrated with the aluminum extraction method described above with respect to FIG. 1, e.g., where the mixture of the metal hydroxide compounds is prepared by the above-described method of precipitation using caustic sodium hydroxide to reduce or eliminate aluminum.

According to this method, and referring to FIG. 2, hydroxide compounds comprising rare earth metal hydroxides, thorium hydroxide, barium hydroxide and base metal hydroxides including iron hydroxide and manganese hydroxide are contacted with sulfuric acid (H₂SO₄) and oxalic acid (H₂C₂O₄), e.g., in a mixer/reactor 210 to form oxalate/double sulfate precipitates that may include rare earth metal oxalates, rare earth metal double sulfates, thorium oxalate and barium sulfate. Substantially all of the base metals are solubilized in the resulting acidic liquid. Thus, the contacting step selectively separates the rare earth metals, thorium and barium from the solubilized base metals.

In one characterization, the step of contacting the first hydroxide precipitate phase with sulfuric acid and oxalic acid, e.g., in mixer/reactor 210, is carried out at an H₂SO₄ acidity of at least about 5M, such as at least about 6M. In another characterization, the contacting step includes contacting the mixture of metal hydroxide compounds with sulfuric acid and oxalic acid substantially simultaneously. In another characterization, concentration of sulfuric acid in the acidic liquid, e.g., the equilibrium free acid concentration, is at least about 50 grams per liter (gpl), such as at least about 55 gpl, and is not greater than about 85 gpl, such as not greater than about 80 gpl. In one particular characterization, the concentration of sulfuric acid in the acidic liquid is at least about 70 gpl and is not greater than about 80 gpl. In another characterization, the concentration of oxalic acid (H₂C₂O₄) in the acidic liquid is at least about 3 gpl, such as at least 4 gpl, and is not greater than about 10 gpl, such as not greater than about 8 gpl.

The method, particularly when carried out within the foregoing parameters, results in the separation of base metals from the rare earth metals, e.g., where the base metals are solubilized and report to the acidic liquid comprising sulfuric acid and oxalic acid. In one characterization, the oxalate/double sulfate precipitates comprise not greater than about 5 wt. %, such as not greater than about 2 wt. %, such as not greater than 1 wt. %, or even not greater than 0.5 wt. % of the other base metals from the mixture of metal hydroxide compounds. The bulk of the base metals reporting to the acidic liquid may include iron, titanium, manganese, magnesium and calcium, for example.

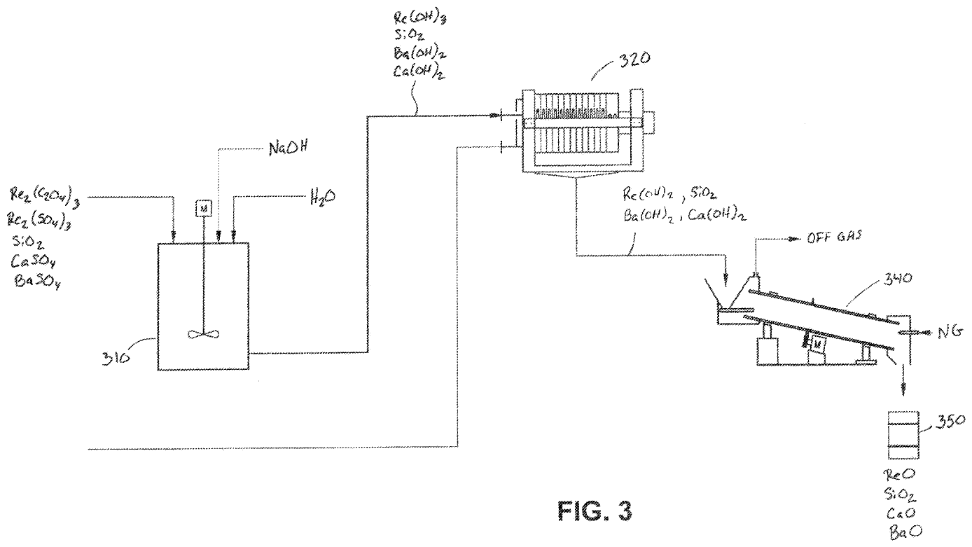

As illustrated in FIG. 2, the method may also include the step of contacting the acidic liquid with sodium carbonate and sodium hydroxide, e.g., in a mixer/reactor 212 to precipitate the other base metals as metal carbonate compounds. Separation of the metal carbonate compounds, e.g., in a filter press 222 forms a base metal depleted liquid. The sodium hydroxide may be recycled from a solution that is obtained by a subsequent metathesis step, e.g., as illustrated in FIG. 3 and discussed below. After precipitation of the base metals as carbonate compounds, the filtrate which is substantially base metal free may be treated to recover sodium oxalate and sodium sulfate, e.g., as salable by-products. As illustrated in FIG. 2, the these by-products may be recovered by sequential cooling of the base metals depleted solution in cooling tanks 230 and 232 and separation in filter presses 224 and 226.

According to another embodiment of the present disclosure, and as illustrated in FIG. 3, a method is disclosed for the conversion of a mixture of metal oxalate compounds and metal double sulfate compounds to metal hydroxide compounds. This method, referred to herein as metathesis, may be carried out independently, or may be integrated with the sulfuric acid leach step as described above with reference to FIG. 2, e.g., where the source of the mixture of metal oxalate compounds and metal double sulfate compounds is the method described above with respect to FIG. 2.

The method includes contacting the mixture of metal oxalate compounds and metal double sulfate compounds with a caustic sodium hydroxide solution to metathesize the metal double sulfate compounds and the metal oxalate compounds to insoluble metal hydroxide compounds and form: (i) metal hydroxide compounds comprising rare earth metal hydroxides, thorium hydroxide, cerium hydroxide and barium hydroxide, and that is substantially free of sulfate and oxalate compounds, and (ii) a bulk solution comprising sodium oxalate. Such a contacting step may be carried out in mixer/reactor 310. Thereafter, the metal hydroxide compounds may be filtered off, e.g., separated, from the bulk solution using a filter press 320.

In one characterization, the step of contacting the mixture of metal oxalate compounds and double sulfate compounds with the caustic sodium hydroxide solution is carried out in the mixer/reactor 310 at a temperature of at least about 75° C., such as at least about 80° C., and not greater than about 95° C., such as not greater than about 90° C. The contact time may be at least about 1 hour and not greater than about 2 hours, for example. In another characterization, the caustic sodium hydroxide solution has a concentration of at least about 40 wt. % NaOH, such as at least about 45 wt. % NaOH, and not greater than about 60 wt. % NaOH, such as not greater than about 55 wt. % NaOH. The amount of NaOH utilized in the reaction may be substantially stoichiometric with respect to the oxalate and double sulfate compounds that are being converted to hydroxide compounds, so that the consumption of NaOH Is relatively small, and excess NaOH may be recycled to the precipitation of base metals from sulfuric acid solution formed during the sulfuric acid leach described above.

Once the metal hydroxide compounds are formed and separated from the bulk sodium hydroxide solution, they may be calcined to form calcined metal oxide compounds comprising rare earth metal oxides, barium oxide and silicate compounds. For example, the metal hydroxide compounds may be calcined in a rotary kiln 340 fueled by natural gas NG at a temperature of at least about 670° C., such as at least about 690° C., in an oxidizing atmosphere, e.g., in air or an oxygen-rich atmosphere. As a result, at least the cerium oxide and the thorium oxide will include Th and Ce in the +4 valence state. The resulting metal oxides may be stored, e.g., in tote 350, for further processing.

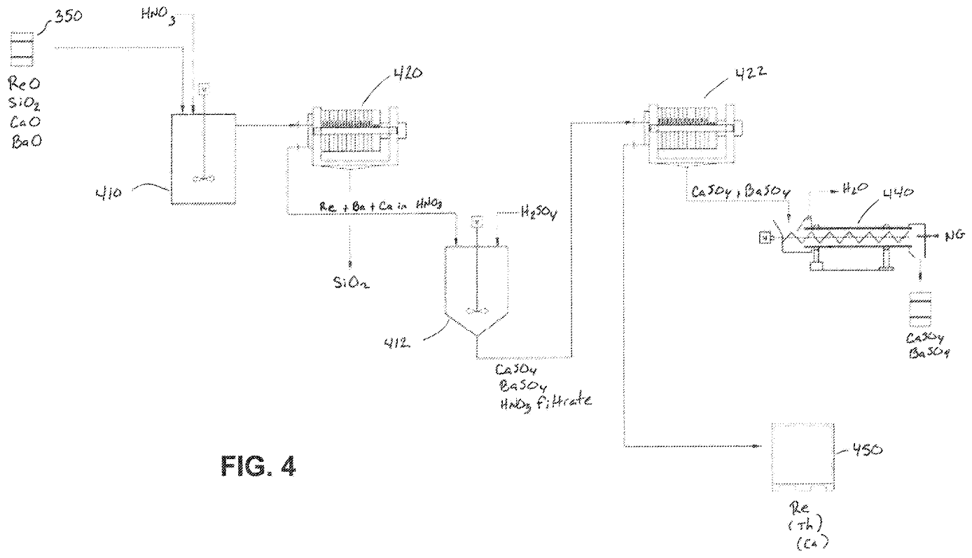

According to another embodiment, and as illustrated in FIG. 4, a method for the recovery of barium from metal oxide compounds comprising rare earth metal oxides, barium oxide, silicate compounds, cerium oxide and thorium oxide is disclosed. In one characterization, the feed for this process is produced as described above with respect to FIG. 3 and is supplied in tote 350. The method, referred to herein as a nitric acid digestion step, includes contacting the metal oxide compounds with nitric acid to form a bulk nitrate solution comprising solubilized rare earth metal nitrates, barium nitrate, calcium nitrate, cerium nitrate and thorium nitrate, and a gangue phase comprising silicate compounds, e.g., SiO₂. Such a contacting step may be carried out in mixer/reactor 410.

In one characterization, the weight ratio of nitric acid to metal oxide compounds input to the contacting step in mixer/reactor 410 is at least about 1:1, such as at least about 1.1:1 or even at least about 1.2:1. In another characterization, the bulk nitrate solution recovered from the filter press 420 comprises not greater than about 0.05 wt. % base metals on a metals basis.

The bulk nitrate solution is filtered off from the insoluble gangue phase, e.g., using filter press 420. Subsequently, the nitrate solution is contacted with sulfuric acid in mixer/reactor 412 to precipitate barium sulfate from the bulk nitrate solution. This solution is separated from the nitrate solution, e.g., using filter press 422, to form a barium-depleted nitrate solution containing the rare earth elements. As illustrated in FIG. 4, if the metal oxide compounds also include calcium oxide, the calcium will precipitate with the barium in the form of calcium sulfate (CaSO₄). Barium sulfate and calcium sulfate may be dried, e.g., in a rotary dryer 440, and are salable by-products that may reduce the operating cost for the process. The Re-bearing nitrate solution may be stored, e.g., in container 450, for further processing.

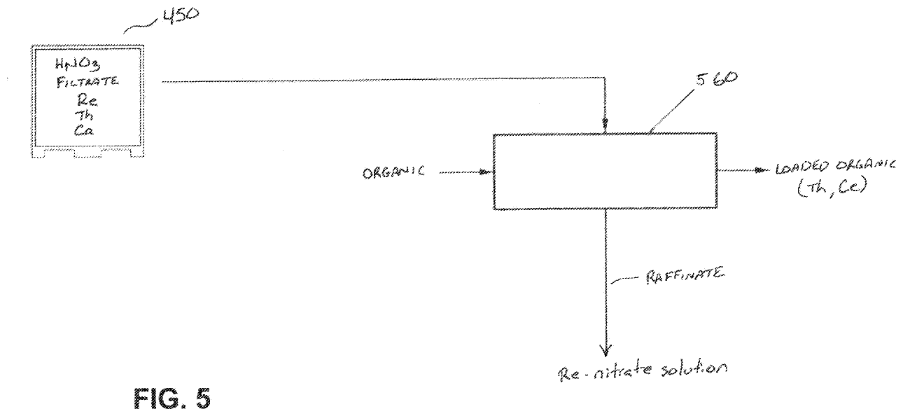

In yet another embodiment, and as illustrated in FIG. 5, a method for the recovery of thorium and cerium from a bulk nitrate solution is disclosed, where the bulk nitrate solution also includes rare earth metals in addition to thorium and cerium. The method, referred to herein as selective solvent extraction, includes the steps of: (i) contacting the bulk nitrate solution with a an extractant mixture comprising at least about 20 wt. % of a phosphinic acid extractant, such as a dialkyl phosphinic acid extractant, in a diluent at an oxygen-reduction potential (ORP) of at least about 1000 mV and not greater than about 1500 mV and a pH of about pH 1 or less; (ii) wherein at least about 99.9% of the thorium and at least about 75% of the cerium from the bulk nitrate solution are extracted in a single extraction step, and (iii) wherein the thorium and the cerium in the bulk nitrate solution are in the +4 oxidation state.

The bulk nitrate solution comprising rare earth elements may be produced in accordance with the method described above with respect to FIG. 4, e.g. provided in a container 450. In another characterization, the bulk nitrate solution has a high acidity. For example, the pH of the bulk nitrate solution may be not greater than about pH 0.5, such as not greater than about pH 0.2.

The nitrate solution is contacted with the organic extractant in a solvent extraction circuit 560. In one characterization, the extractant mixture comprises at least about 25 wt. % dialkyl phosphinic acid extractant in the diluent, such as at least about 30 wt. % dialkyl phosphinic acid extractant in the diluent. One example of a useful dialkyl phosphinic acid extractant is CYANEX 272 available from the Solvay Corporation.

When the method is carried out under the foregoing conditions, it has been found that at least about 90%, such as at least about 95% of the cerium from the bulk nitrate solution can be extracted in a single extraction step. In addition, this selective solvent extraction method may remove at least about 99% of the thorium from the bulk nitrate solution, such as at least about 99.5% or at least about 99.9% or higher. The resulting Re-nitrate solution will have a very high purity with respect to rare earth metals and can be further processed for the selective extraction of those rare earth metals. In addition, it has been found that the contact time with the organic extractan may be very small, such as 8 minutes or less, to achieve such high extraction rates.

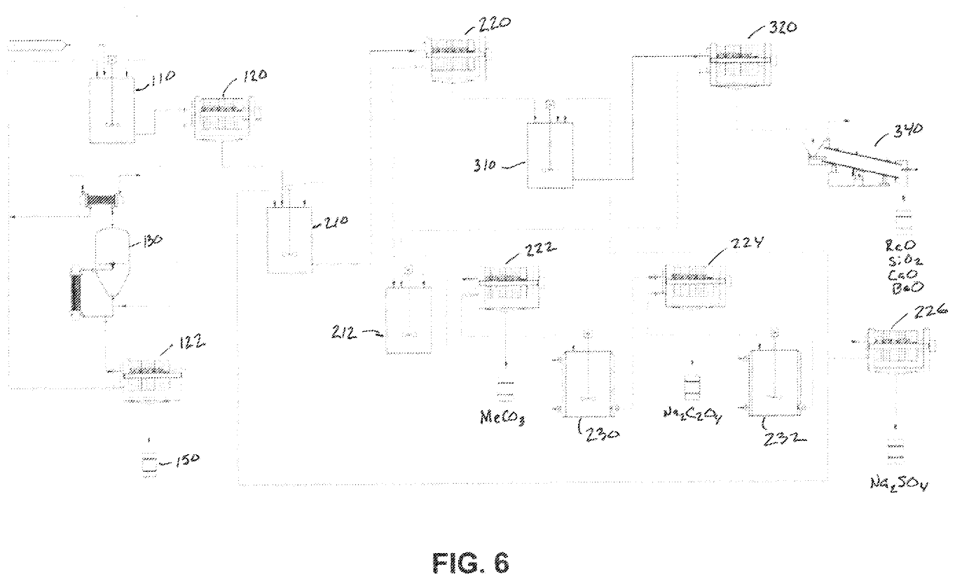

As noted above, the foregoing methods may be implemented individually or in any combination. For example. FIG. 6 illustrates a flowsheet wherein the steps of aluminum extraction, sulfuric acid leaching and metathesis are combined such that the mineral-rich concentrate is processed to form metal oxide compounds, e.g., of rare earth metals, thorium and barium, where the metal oxide compounds are substantially free of aluminum and other base metals.

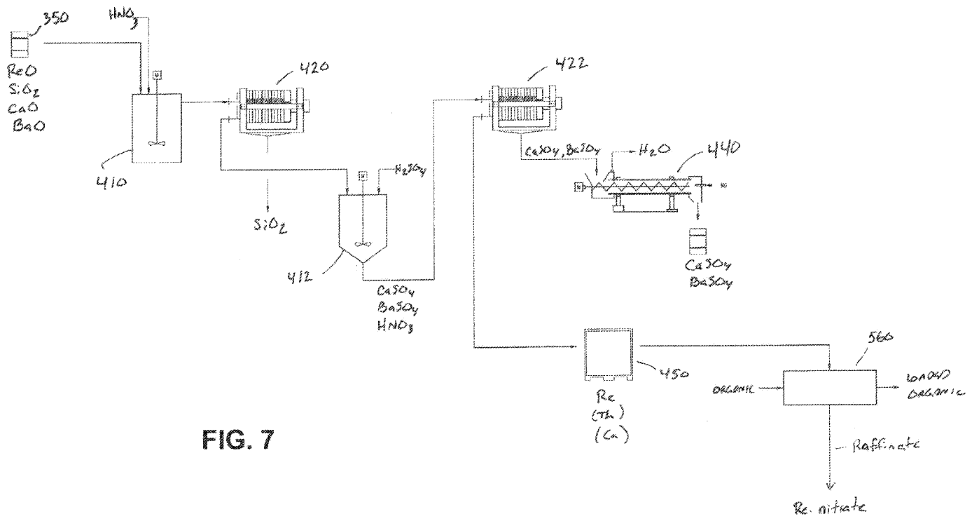

FIG. 7 illustrates a flowsheet wherein the metal oxide compounds, e.g., as formed by the flowsheet illustrated in FIG. 6, are treated by nitric acid digestion and selective solvent extraction, e.g., as described with respect to FIG. 4 and FIG. 5. As a result, the metal oxide compounds of rare earth metals, thorium and barium are treated by digestion and solvent extraction to form a solution of rare earth metals of very high purity. For example, after the solvent extraction treatment of the bulk nitrate solution to remove cerium and thorium, the nitrate solution may be treated to separate the remaining rare earth metals. For example, neodymium and praseodymium (Nd/Pr) may be separated in 4 mixer/settlers using a mixture of phosphoric and phosphinic extractants. Other rare earth metals such as lanthanum, SEG (samarium, europium and gadolinium), dysprosium (Dy), terbium (Tb) and yttrium (Y) may be separated by solvent extraction and/or alkaline precipitation methods.

The methods described herein may provide one or more advantages, such as:
a shortened path from monazite-rich ore to high purity rare earth metals;
reduced reagent costs;
reduced energy consumption;
the elimination of base metal removal by solvent extraction;
little or no effluent;
the formation of valuable by-products to reduce the overall cost of the process.

Table I illustrates a hypothetical material input to the method illustrated by the flowsheets of FIG. 6 and FIG. 7, i.e., to treat 76 metric tonnes of a monazite-rich concentrate to recover a high purity rare earth solution and other valuable by-products:

TABLE I
Mass Balance

| | Metric tonnes per day |
|---|---|
| Process Inputs | |
| Monazite Concentrate | 76 |
| NaOH (caustic cracking) | 22 |
| NaOH (metathesis) | 67 |
| H₂SO₄ | 591 |
| H₂C₂O₄•2H₂O | 19 |
| HNO₃ | 32 |
| Na₂CO₃ | 534 |
| Process Outputs | |
| Rare Earth Oxides | 7.8 |
| Na₂SO₄ | 1,921 |
| CeO₂ | 4.7 |
| ThO₂ | 0.5 |
| Na—Al—P complex | 19.7 |
| Ba₅O₄ | 11.0 |
| Base Metals Total | 26.1 |
| Fe (metals basis) | 9.9 |
| Mn (metals basis) | 3.2 |
| Al (metals basis) | 0.11 |

Table II illustrates the energy requirements and energy balance for the flowsheet illustrated in FIG. 6 and FIG. 7, i.e., to treat 76 metric tonnes of a monazite-rich concentrate:

TABLE II
Energy Balance

| | | | Power Eq. | |
|---|---|---|---|---|
| | MMBTU/HR | | (MW) | |
| AREA | HEATING | CHILLING | Standard | MVR |
| Area 100 - Caustic Crack | | | | |
| Area 150 - Phosphate Crystallization | 142 | | 41.7 | 15 |
| Area 200 - Base Metals Recovery | 6 | | 1.8 | 2 |
| Area 300 - Triple Metathesis & | 51 | | 15.0 | 15 |
| Calcination | | | | |
| Area 400 - Nitric Acid Leach | | | | |
| Area 500 - Barium Precipitation | | | | |
| Area 600 - Th & Ce Extraction | | | | |
| Area 700 - Rare Earth Precipitation | 0.3 | | 0.1 | |
| Area 800 - Effluent Treatment & Reagent | 5 | 22 | 2.4 | 1.6 |
| Recovery | | | | |
| Totals: | 205 | 22 | 61 | 33 |

Two evaporative crystallization units are present in the process block flow diagram. These units may be designed using mechanical vapor recompression (MVR) equipment to significantly reduce they energy consumption, as can be seen in Table II above. Generally, a MVR evaporator utilizes approximately 35% of the energy required using only heat.

While various embodiments of a method for the recovery of rare earth metals from mineral-rich ore concentrates have been described in detail, it is apparent that modifications and adaptations of those embodiments will occur to those skilled in the art. However, is to be expressly understood that such modifications and adaptations are within the spirit and scope of the present disclosure.

What is claimed is:

1. A method for the selective extraction of metals from a mineral-rich concentrate comprising compounds of rare earth metals, aluminum, phosphorous, thorium, barium and base metals comprising at least iron and manganese, comprising the steps of:
contacting the mineral-rich concentrate with a caustic sodium hydroxide solution at a temperature of at least about 130° C. and at a weight ratio of sodium hydroxide to mineral-rich concentrate of at least about 1:1 to form metal hydroxide compounds comprising at least rare earth metal hydroxides, thorium hydroxide and barium hydroxide, and a rare earth metal depleted sodium hydroxide solution comprising a solubilized Na—Al—P complex;
filtering off the metal hydroxide compounds from the rare earth metal depleted sodium hydroxide solution; and
recovering Na—Al—P complex crystals from the rare earth metal depleted sodium hydroxide solution.

2. A method for the separation of metal hydroxide compounds of rare earth metals, thorium and barium, from a mixture of those metal hydroxide compounds with base metal hydroxide compounds comprising iron hydroxide and manganese hydroxide, the method comprising the steps of:
contacting the mixture of metal hydroxide compounds with sulfuric acid and oxalic acid to form insoluble oxalate/double sulfate precipitates comprising rare earth metal oxalates, rare earth metal double sulfates, thorium oxalate, barium sulfate and an acidic liquid comprising solubilized base metals; and
filtering off the oxalate/double sulfate precipitates from the acidic liquid.

3. A method for the conversion of a mixture of metal oxalate compounds and metal double sulfate compounds to metal hydroxide compounds, comprising the steps of:
contacting the mixture of metal oxalate compounds and metal double sulfate compounds with a caustic sodium hydroxide solution to metathesize the metal double sulfate compounds and the metal oxalate compounds to insoluble metal hydroxide compounds and form: (i) metal hydroxide compounds comprising rare earth metal hydroxides, thorium hydroxide, cerium hydroxide and barium hydroxide, and that is substantially free of sulfate and oxalate compounds, and (ii) a bulk solution comprising sodium oxalate;
filtering off the metal hydroxide compounds from the bulk solution; and
calcining the metal hydroxide compounds at a temperature of at least about 670° C. in an oxidizing atmosphere to form calcined metal oxide compounds comprising rare earth metal oxides, barium oxide, silicate compounds, cerium oxide having cerium in a +4 valence state and thorium oxide having thorium in a +4 valence state.

4. A method for the recovery of barium from metal oxide compounds comprising rare earth metal oxides, barium oxide, calcium oxide, silicate compounds, cerium oxide and thorium oxide, comprising the steps of:
contacting the metal oxide compounds with nitric acid to form a bulk nitrate solution comprising solubilized rare earth metal nitrates, barium nitrate, calcium nitrate, cerium nitrate and thorium nitrate, and a gangue phase comprising silicate compounds;
filtering off the bulk nitrate solution from the gangue phase;
contacting the bulk nitrate solution with a substantially stoichiometric amount of sulfuric acid to precipitate barium sulfate from the bulk nitrate solution and form a barium-depleted nitrate solution; and
filtering off the barium sulfate from the barium-depleted nitrate solution.

5. A method for the recovery of thorium and cerium from a bulk nitrate solution comprising thorium and rare earth metals including cerium, comprising the steps of:
contacting the bulk nitrate solution with a an extractant mixture comprising at least about 20 wt. % dialkyl phosphinic acid extractant in a diluent at an oxygen-reduction potential (ORP) of at least about 1000 mV and not greater than about 1500 mV and a pH of about pH 1 or less;
wherein at least about 99.9% of the thorium and at least about 75% of the cerium from the bulk nitrate solution are extracted in a single extraction step, and
wherein the thorium and the cerium in the bulk nitrate solution are in the +4 oxidation state.

6. The method recited in claim 2, wherein the metal hydroxide compounds are formed by the method recited in claim 1.

7. The method recited in claim 3, wherein the mixture of metal oxalate compounds and metal double sulfate compounds is formed by the method recited in claim 2.

8. The method recited in claim 4, wherein the metal oxide compounds are formed by the method recited in claim 3.

9. The method recited in claim 5, wherein the bulk nitrate solution is formed by the method recited in claim 4.

10. The method recited in any one of claim 1 or 6, wherein the mineral-rich concentrate comprises monazite.

11. The method recited in any one of claim 1, 6 or 10 wherein the mineral-rich concentrate has an average particle size of not greater than about 20 μm.

12. The method recited in any one of claim 1, 6, 10 or 11, wherein the base metals further comprise titanium.

13. The method recited in any one of claim 1, 6 or 10-12, wherein the mineral-rich concentrate comprises at least about 4 wt. % rare earth metals on a metals basis.

14. The method recited in any one of claim 1, 6 or 10-13, wherein the mineral-rich concentrate comprises not greater than about 20 wt. % rare earth metals on a metals basis.

15. The method recited in any one of claim 1, 6 or 10-14, wherein the mineral-rich concentrate comprises at least about 5 wt. % aluminum on a metals basis.

16. The method recited in any one of claim 1, 6 or 10-15, wherein the mineral-rich concentrate comprises not greater than about 8 wt. % aluminum on a metals basis.

17. The method recited in any one of claim 1, 6 or 10-16, wherein the mineral-rich concentrate comprises at least about 10 wt. % barium on a metals basis.

18. The method recited in any one of claim 1, 6 or 10-17, wherein the mineral-rich concentrate comprises not greater than about 25 wt. % barium on a metals basis.

19. The method recited in any one of claim 1, 6 or 10-18, wherein the step of contacting the mineral-rich concentrate with the caustic sodium hydroxide solution comprises mixing the mineral-rich concentrate and the caustic sodium hydroxide solution in a reactor to form a slurry having a solids concentration of not greater than about 20 wt. %.

20. The method recited in any one of claim 1, 6 or 10-19, wherein the weight ratio of phosphates to aluminum in the mineral-rich concentrate is at least about 1.2:1.

21. The method recited in any one of claim 1, 6 or 10-20, wherein the caustic sodium hydroxide solution has a concentration of at least about 40 wt. % NaOH.

22. The method recited in any one of claim 1, 6 or 10-21, wherein the caustic sodium hydroxide solution has a pH of at least about pH 12.

23. The method recited in any one of claim 1, 6 or 10-22, wherein the step of contacting the mineral-rich concentrate with the caustic sodium hydroxide solution occurs at a temperature of at least about 135° C.

24. The method recited in any one of claim 1, 6 or 10-23, wherein the step of contacting the mineral-rich concentrate with the caustic sodium hydroxide solution comprises a second contacting step wherein the metal hydroxide compounds are contacted with the caustic sodium hydroxide solution to further reduce the concentration of aluminum in the metal hydroxide compounds.

25. The method recited in any one of claim 1, 6 or 10-24, wherein at least about 98% of the aluminum in the mineral-rich concentrate reports to the rare earth metal depleted sodium hydroxide solution.

26. The method recited in any one of claim 1, 6 or 10-25, further comprising the step of:
recycling the rare earth metal depleted sodium hydroxide solution to the step of contacting the mineral-rich concentrate with a first caustic sodium hydroxide solution.

27. The method recited in any one of claim 1, 6 or 10-26, wherein the step of recovering Na—Al—P crystals comprises evaporative crystallization of the Na—Al—P crystals from the rare earth metals depleted sodium hydroxide solution.

28. The method recited in any one of claim 2, 6 or 7, wherein the step of contacting the mixture of metal hydroxide compounds with sulfuric acid and oxalic acid is carried out at an acidity of at least about 5 M H₂SO₄.

29. The method recited in any one of claim 2, 6, 7 or 28, wherein the step of contacting the mixture of metal hydroxide compounds with sulfuric acid and oxalic acid comprises contacting the mixture of metal hydroxide compounds with sulfuric acid and with oxalic acid substantially simultaneously.

30. The method recited in any one of claim 2, 6, 7, 28 or 29, wherein the concentration of sulfuric acid in the acidic liquid is at least about 50 gpl and is not greater than about 85 gpl.

31. The method recited in any one of claim 2, 6, 7 or 28-30, wherein the concentration of oxalic acid in the acidic liquid is at least about 4 gpl and is not greater than about 8 gpl.

32. The method recited in any one of claim 2, 6, 7 or 28-31, wherein the insoluble oxalate/double sulfate precipitates comprise not greater than about 0.5 wt. % of the other base metals from the mixture of metal hydroxide compounds on a metals basis.

33. The method recited in any one of claim 2, 6, 7 or 28-32, further comprising the steps of:
contacting the acidic liquid with sodium carbonate and sodium hydroxide to precipitate the other base metals as metal carbonate compounds and form a base metal depleted liquid.

34. The method recited in claim 33, wherein the sodium hydroxide is derived from the bulk solution formed according to claim 3.

35. The method recited in any one of claim 33 or 34, further comprising the steps of:
precipitating sodium oxalate from the base metals depleted liquid; and
precipitating sodium sulfate from the base metals depleted liquid.

36. The method recited in any one of claim 3 or 7-9, wherein the step of contacting the mixture of metal oxalate compounds and double sulfate compounds with the caustic sodium hydroxide solution is carried out at a temperature of at least about 75° C. and not greater than about 95° C.

37. The method recited in any one of claim 3, 7-9 or 36, wherein the caustic sodium hydroxide solution has a concentration of at least about 40 wt. % NaOH and not greater than about 60 wt. % NaOH.

38. The method recited in any one of claim 3, 7-9, 36 or 37, wherein the calcining step is carried out at a temperature of at least about 690° C.

39. The method recited in any one of claim 3, 7-9, or 36-38, wherein the calcined metal oxide compounds have a mass that is at least about 45% of the mass of the mineral-rich concentrate of claim 1.

40. The method recited in claim 39, wherein the calcined metal oxide compounds have a mass that is at least about 48% of the mass of the mineral-rich concentrate of claim 1.

41. The method recited in any one of claim 4, 8 or 9, wherein the weight ratio of nitric acid to metal oxide compounds input to the contacting step is at least about 1.1:1.

42. The method recited in any one of claim 4, 8, 9 or 41, wherein the bulk nitrate solution comprises not greater than about 0.05% base metals on a metals basis.

43. The method recited in claim 5, wherein the extractant mixture comprises at least about 25 wt. % dialkyl phosphinic acid extractant in a diluent.

44. The method recited in claim 43, wherein the extractant mixture comprises at least about 30 wt. % dialkyl phosphinic acid extractant in a diluent.

45. The method recited in any one of claim 5, 43 or 44, wherein the pH of the mixture is not greater than pH 0.5.

46. The method recited in claim 45, wherein the pH of the mixture is not greater than pH 0.2.

47. The method recited in any one of claim 5 or 43-46, wherein at least about 95% of the cerium from the bulk nitrate solution is extracted in a single extraction step.
